(19) United States
(12) Patent Application Publication
(10) Pub. No.: US 2009/0164911 A1
(43) Pub. Date: Jun. 25, 2009

(54) SYSTEMS, METHODS AND COMPUTER PROGRAM PRODUCTS FOR CREATING PARENT/CHILD ENTRIES FOR A CALENDAR EVENT TO ENABLE CUSTOMIZATION FOR CALENDAR-EVENT ATTENDEES

(75) Inventors: Susan M. Cox, Rochester, MN (US); Janani Janakiraman, Austin, TX (US); Fang Lu, Billerica, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/960,210

(22) Filed: Dec. 19, 2007

(51) Int. Cl. G06F 3/00

(52) U.S. Cl. 715/751

(57) ABSTRACT

Systems, methods and computer program products for a parent/child approach to calendar-event notices with user-set selective enabling of which child is displayed. Systems, methods and computer program products described herein include a method for generating a notice for a calendar-event, the method including identifying calendar event criteria and attendees for the calendar-event, creating a notice for the calendar-event including parent calendar event criteria, enabling child attachments for the calendar-event notice, setting preferences for the child attachments, creating the child attachment with child calendar event criteria and attaching the child attachment to the calendar-event notice, associating the parent calendar-event criteria with the child calendar-event criteria and selecting which child calendar-event criteria is displayed with the parent calendar-event criteria in response to displaying the parent calendar-event criteria on a computer.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to electronic calendar applications, and particularly to systems, methods and computer program products for creating parent/child entries for a calendar event to enable customization for calendar-event attendees.

2. Description of Background

Todays remotely distributed teams schedule calendar-events across multiple locations. Multiple people are often responsible for reserving conference rooms at the various locations. These can't be added back into the original calendar-event notice except by the single originator of the calendar-event (or those few with calendar access). Further, it is not desirable for everyone to have to see site specific information for all the sites. A more typical workaround is for a secondary person at each site to send out a duplicate calendar-event notice with the site specific information. Typically, the scheduling tools highlight this calendar-event as conflicting with an already scheduled calendar-event; and the user's calendar is cluttered. The current setup doesn't have the look and feel of a fully functional collaboration enabling tool.

### SUMMARY OF THE INVENTION

Systems, methods and computer program products described herein include a method for generating a notice for a calendar-event, the method including identifying calendar event criteria and attendees for the calendar-event, creating a notice for the calendar-event including parent calendar event criteria, enabling child attachments for the calendar-event notice, setting preferences for the child attachments, creating the child attachment with child calendar event criteria and attaching the child attachment to the calendar-event notice, associating the parent calendar-event criteria with the child calendar-event criteria and selecting which child calendar-event criteria is displayed with the parent calendar-event criteria in response to displaying the parent calendar-event criteria on a computer.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Field

As a result of the summarized invention, technically we have achieved a solution which provides systems, methods and computer program products that implement a Parent/Child approach to calendar-event notices to allow for different “children” (e.g. site specific conference rooms) to be associated with the same main “parent” (time/subject), combined with user-set selective enabling of which “child” is displayed on a per user basis. As such, it is appreciated that in exemplary embodiments, people scheduling calendar-events would have a choice.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a for creating parent/child entries for a calendar event to enable customization for calendar-event attendees; and

FIG. 2 illustrates a flow chart of a method for creating parent/child entries for a calendar event to enable customization for calendar-event attendees.

The detailed description explains the preferred embodiments of the invention, together with advantages and features, by way of example with reference to the drawings.

### DETAILED DESCRIPTION OF THE INVENTION

Exemplary embodiments include systems, methods and computer program products that implement a Parent/Child approach to calendar-event (e.g., meeting) notices to allow for different “children” (e.g. site specific conference rooms) to be associated with the same main “parent” (time/subject), combined with user-set selective enabling of which “child” is displayed on a per user basis. In exemplary embodiments, the systems, methods and computer program products separate the data in a calendar-event notice into two sets. The “parent” portion contains all information that is common to all attendees. The various “children” portions contain information only pertinent to an individual attendee or to a subgroup of attendees. As such, it is appreciated that in exemplary embodiments, people scheduling calendar-events would have a choice.

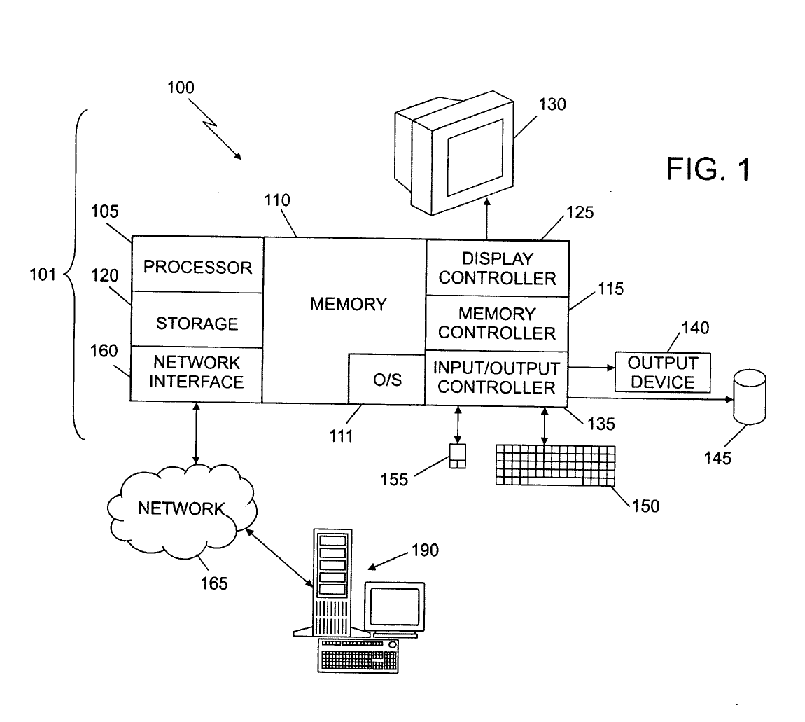

FIG. 1 illustrates an exemplary embodiment of a system 100 for creating parent/child entries for a calendar event to enable customization for calendar-event attendees. The methods described herein can be implemented in software (e.g., calendar applications), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the scheduling methods described herein in accordance with exemplary embodiments and a suitable operating system (OS) 111. The operating system 111 essentially controls the execution of other computer programs, such the scheduling systems and methods described herein, and provides scheduling, input-output control, file and data management, memory management, and communication control and related services.

The scheduling methods described herein may be in the form of a source program, executable program (object code), script, or any other entity comprising a set of instructions to be performed. When the program is a source program, the program can be translated via a compiler, assembler, interpreter, or the like, which may or may not be included within the memory 110. Furthermore, the scheduling methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals. In exemplary embodiments, it is appreciated that several additional computers such as computer 190 can be in communication with the network 165 such that the computer 101 can coordinate the parent/child schedule methods described herein.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The scheduling methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The scheduling methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the scheduling methods are implemented in hardware, the scheduling methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described herein, people scheduling calendar-events would have a choice. If all attendees are co-located or no user specific information was desired by attendees—the originator could choose the current type of calendar-event notice. But in cases where attendees wish to tack on their own information, the originator would choose the option to “enable child attachments”. In exemplary embodiments, the originator would include the calendar-event time, subject matter, required and optional attendee lists and supportive information such as an e-calendar-event link with password, agenda information, shared team room links or presentations in the parent calendar-event notice. Default location and/or conference call number and pass code would exist, which could be implemented as part of the parent or part of a child.

In exemplary embodiments, any attendee is then able to create a child attachment to suit their needs. In exemplary, a secondary project leader at a remote site can reserve a local conference room and put this in their newly created child attachment. The originator also can create a child attachment for their site attendees. Individuals may or may not create a child attachment for their needs (to reserve space, or have a holding document for their personal calendar-event minutes, for example). Once submitted, individual attendees see the appropriate child attachment based on their preset preferences.

Currently, some international calls list multiple regions with associated call-in numbers in free text format. In exemplary embodiments, the systems, methods and computer program products described herein can generate fields or elements for entry of region and conference call number, so a program can appropriately display only the pertinent set per attendee, based on their previously mentioned preferences. In exemplary embodiments, a repeated set of region/call-in numbers could be grouped into a pre-configured shortcut tag or name, which can be entered into subsequent calendar-event notices using the shortcut tag or name.

In exemplary embodiments, sub-teams can create their own subgroup names and set subgroup preferences, similar to setting individual preferences. Individuals can specify whether to set their preferences to a particular existing subgroup, or have individual preference settings. In addition, preferences can be set based on a variety of stored databases (e.g., local sets of subgroups, computers associated with attendees and information related to each of the attendees). Existing presence detection software can be used to determine whether the attendee is signing on from their main office, home or travel site to automatically change the displayed child as the attendee moves around. The appropriately displayed child can be based on a combination of attendee location and attendee preferences. For example, on a business trip, the local, on-site child can be used for conference room information, rather than the conference call number described herein (if at the main office) or the external call in number (if at home).

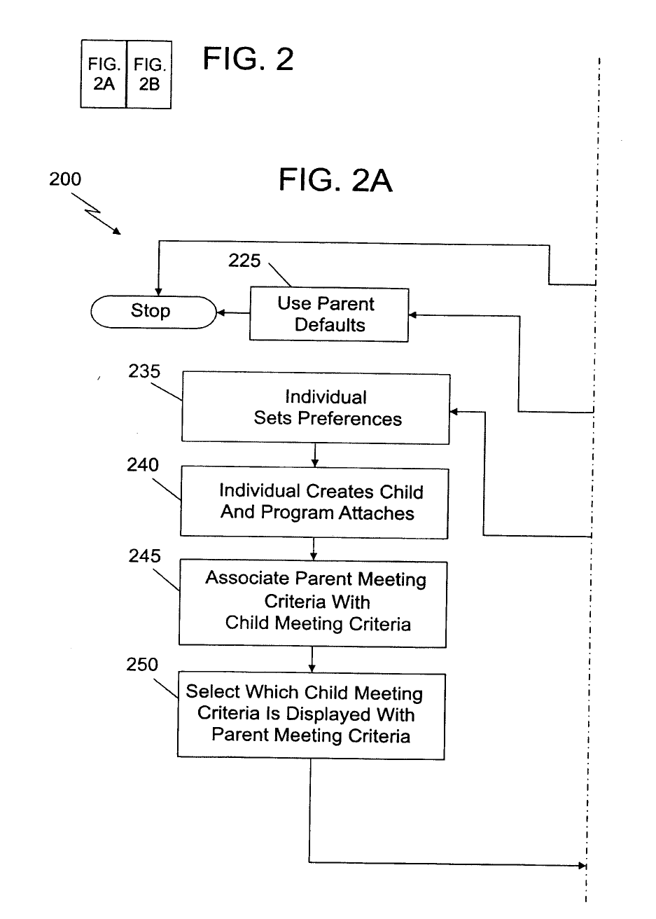

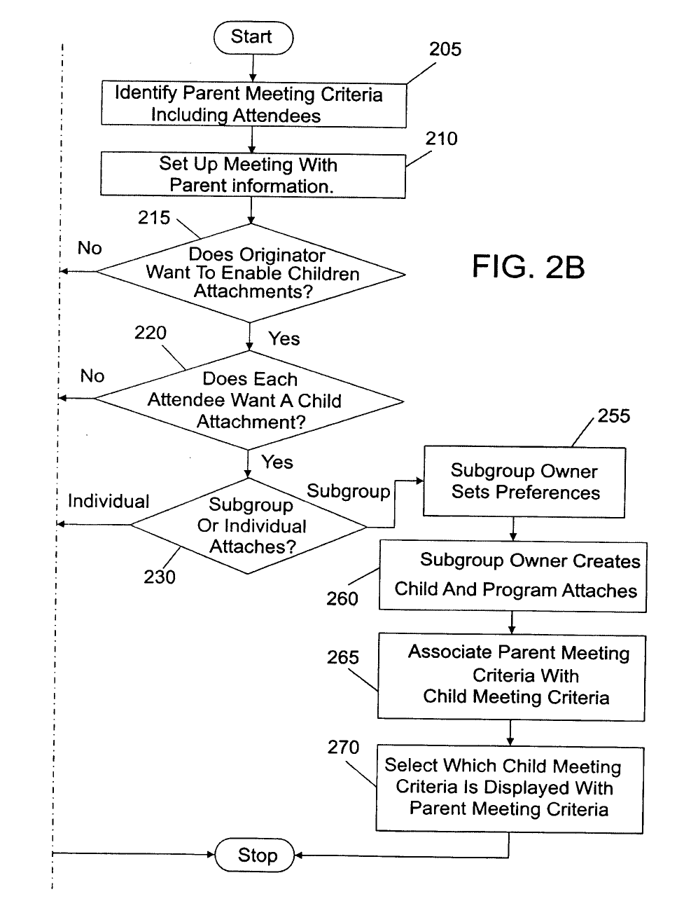

FIG. 2 illustrates a flow chart of a method 200 for creating parent/child entries for a calendar event to enable customization for calendar-event attendees. At block 205, the method 200 identifies parent meeting criteria, which includes identifying calendar-event attendees who are recipients for the notice for the calendar-event. At block 210, the method sets up a meeting with parent information, which can include default information as described here. At block 215, the method 200 determines whether or not the originator of the calendar-event (e.g., meeting) wants to enable child attachments. If the originator does not want to enable child attachments at block 215, then the flow ends. If the originator does want to enable child attachments at block 215, then at block 220, the method 200 determines if each attendee (including the originator) wants a child attachment. If a given attendee does not want a child attachment at block 220, then at block 225, the method 200 enables parent defaults and the flow ends. If a given attendee does want a child attachment at block 220, then at block 230, the method determines if the sub-group or the individual includes the attachment(s). If the individual determines the preferences at block 230, then at block 235, the individual attendee sets the preference. At block 240, the individual attendee creates (or the method 200 creates based on preferences) the child attachment and the method 200 automatically attaches the child attachment to the notice. At block 245, the method 200 associates the parent meeting criteria with the child meeting criteria. At block 250, the method 200 selects which child meeting criteria is displayed with the parent meeting criteria in the notice.

Returning to block 230, if the sub-group determines the preferences, then at block 255, the sub-group owner sets the preference. At block 260, the sub-group owner creates (or the method 200 creates based on preferences) the child attachment and the method 200 automatically attaches the child attachment to the notice. At block 265, the method 200 associates the parent meeting criteria with the child meeting criteria. At block 270, the method 200 selects which child meeting criteria is displayed with the parent meeting criteria in the notice.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for generating a notice for a calendar-event, the method consisting of:
identifying calendar event criteria and attendees for the calendar-event;
creating a notice for the calendar-event including parent calendar event criteria;
enabling child attachments for the calendar-event notice;
setting preferences for the child attachments;
creating the child attachment with child calendar event criteria and attaching the child attachment to the calendar-event notice;
associating the parent calendar-event criteria with the child calendar-event criteria; and
selecting which child calendar-event criteria is displayed with the parent calendar-event criteria in response to displaying the parent calendar-event criteria on a computer.

2. The method as claimed in claim 1 wherein the parent calendar-event criteria includes parent default settings.

3. The method as claimed in claim 2 wherein the child calendar-event criteria includes child default settings.

4. The method as claimed in claim 1 wherein an individual calendar-event attendee sets the preferences for the child attachments, creates and attaches the child attachment with child calendar event criteria and attaching the child attachment to the calendar-event notice.

5. The method as claimed in claim 1 wherein a sub-group owner sets the preferences for the child attachments, creates and attaches the child attachment with child calendar event criteria and attaching the child attachment to the calendar-event notice.
